(19) United States
(12) Patent Application Publication
(10) Pub. No.: US 2007/0108969 A1
(43) Pub. Date: May 17, 2007

(54) Rotational state detecting apparatus

(75) Inventors: Muneaki Kurimoto, Obu-shi (JP); Eiichiro Shigehara, Toyota-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN SEIKI KABUSHIKI KAISHA

(21) Appl. No.: 11/589,174

(22) Filed: Oct. 30, 2006

(30) Foreign Application Priority Data
Oct. 31, 2005 (JP) 2005-316849

(51) Int. Cl. G01B 7/30

(52) U.S. Cl. 324/207.25

(57) ABSTRACT

A rotational state detecting apparatus for detecting a rotational state of a direct current motor using a detection pulse outputted corresponding to rotation of the direct current motor includes a period measuring apparatus for measuring a period of the detection pulse, a period judging apparatus for judging whether the detection pulse is a rotation pulse indicating a rotational frequency of the direct current motor or a divided pulse into which the rotation pulse is divided on the basis of a period difference between a most recent rotation pulse and the detection pulse and a correcting apparatus for correcting the period of the detection pulse to a combined period of a plurality of serial divided pulses and generating the rotation pulse having the combined period in a situation where the detection pulse is judged to be the divided pulse.

### CROSS REFERENCE TO RELATED APPLICATIONS

This application is based on and claims priority under 35 U.S.C. § 119 to Japanese Patent Application 2005-316849, filed on Oct. 31, 2005, the entire content of which is incorporated herein by reference.

### FIELD OF THE INVENTION

This invention generally relates to a rotational state detecting apparatus. More specifically, this invention pertains to a rotational state detecting apparatus for detecting a rotational state of a direct current motor, in particular, a rotational frequency.

### BACKGROUND

A direct current motor is an elemental motor driven on the basis of Fleming's left-hand rule. The motor is convenient because the motor generates torque in proportion to the level of current. In automobiles, the motor is utilized in a wide range of usage. For example, the motor is utilized as a starter motor, a mirror driving motor, a wiper driving motor, a power window driving motor, and a seat driving motor, or the like. For appropriately controlling a position and a velocity of each apparatus, a rotational state of the motor need to be accurately detected. Unlike a stepping motor, the direct current motor is not driven by driving pulses correspondent to a rotational frequency. Accordingly, for knowing the rotational frequency, a rotational state need to be detected by some methods.

There are various methods for detecting the rotational state. An encoder, in which a slit plate provided at a rotational shaft of the motor partially rotates in a photo interrupter, is one of the methods. To detect rotation of a rotational plate with magnetic poles with use of a magnetic sensor is another method. To detect rotational frequency from ripples of current flowing in the motor with use of characteristics of the direct current motor having a brush and an armature without using other sensors as described above, is still another method.

FIG. 8 represents a block diagram schematically illustrating a conventional apparatus for detecting a rotational frequency from ripples of current flowing in the direct current motor. A direct current motor M and a register R are connected in series between a power source voltage B and a ground. Ripples of the current (ripple current) flowing in the direct current motor M are detected as a ripple voltage between the ground and the register R The ripple voltage includes a high-frequency component (in many cases, harmonics of ripple frequency) caused by contact of a brush with an armature. Because the high-frequency component acts as noise, the ripple voltage is formed into ripple pulses RP in a forming portion 5b after the high-frequency component, which normally acts as a noise component, is removed by a filter 5a therefrom. The ripple pulses RP are inputted into a control apparatus configured from a microcomputer and a logical circuit. The control apparatus counts the number of ripple pulses RP. Thus, a rotational frequency can be easily detected.

JP2003-9585A (Patent document 1) describes a rotational state detecting apparatus for detecting a rotational frequency of a direct current motor with use of ripple current flowing in the direct current motor as illustrated in FIG. 8. Conventionally, in a situation where a cutoff frequency of a filter is heightened in order for improving tracking ability of the direct current motor at the time of high-frequency rotation, stability at the time of low-frequency rotation is worsened. On the other hand, in a situation where a cutoff frequency is lowered with importance of stability at the time of low-frequency rotation, tracking ability at the time of high-frequency rotation is worsened. The rotational state detecting apparatus according to the Patent document 1 is configured so that the cutoff frequency of the filter is adjustable corresponding to the rotational frequency of the direct current motor, in other words, corresponding to frequency of the ripple current, and the trade-off described above is eliminated.

A method to detect a rotational frequency with use of ripple current of a direct current motor is simple and effective. Further, in a situation where the cutoff frequency of the filter is variable as described in Patent document 1, more accurate detection is available. However, in a situation where a brush in contact with an armature wears, high-frequency noise components of the ripple current tends to be large. Then, attenuating ability of the filter for the high-frequency noise becomes insufficient, and the high-frequency noise passes through the filter and is formed into pulses (refer to FIG. 9). As a result, the number of ripple pulses increases; and the rotational frequency is detected to be higher than actual one (detected as high speed rotation). Then, because generation of such noise is caused by signals themselves and an instrument itself, which generates the signals, attenuation of the noise leads to attenuation of original signals.

A need thus exists for a rotational state detecting apparatus, in which influence from high-frequency noise can be restricted, and which can accurately detect a rotational state, in particular, a rotational frequency, of a direct current motor. The present invention has been made in view of the above circumstances and provides such a rotational state detecting apparatus.

### SUMMARY OF THE INVENTION

According to an aspect of the present invention, a rotational state detecting apparatus for detecting a rotational state of a direct current motor using a detection pulse outputted corresponding to rotation of the direct current motor includes a period measuring means for measuring a period of the detection pulse, a period judging means for judging whether the detection pulse is a rotation pulse indicating a rotational frequency of the direct current motor or a divided pulse into which the rotation pulse is divided on the basis of a period difference between a most recent rotation pulse and the detection pulse and a correcting means for correcting the period of the detection pulse to a combined period of a plurality of serial divided pulses and generating the rotation pulse having the combined period in a situation where the detection pulse is judged to be the divided pulse.

### BRIEF DESCRIPTION OF THE DRAWINGS

The foregoing and additional features and characteristics of the present invention will become more apparent from the following detailed description considered with reference to the accompanying drawings, wherein:

FIG. 1 represents a block diagram typically illustrating a configuration of a rotational state detecting apparatus according to an embodiment of the present invention;

FIG. 2 represents a waveform chart for explaining a principle of integrating divided input pulses to recover an output pulse from the divided input pulses;

FIG. 3 represents a waveform chart for explaining generation of a divided pulse in a situation where a detection pulse (ripple pulse) is formed from ripple voltage;

FIG. 4 represents a waveform chart illustrating a relation between acceleration/deceleration of a direct current motor and periods of the detection pulses;

FIG. 5 represents a block diagram typically illustrating a configuration example of a rotational state detecting apparatus according to an example of the present invention;

FIG. 6 represents a timing chart for explaining operation in the configuration example illustrated in FIG., 5;

FIG. 7. represents a flowchart for explaining a process example of a control portion illustrated in FIG. 5;

FIG. 8 represents a block diagram typically illustrating a configuration of a conventional rotational state detecting apparatus; and

FIG. 9 represents a waveform chart illustrating an example in which the number of detection pulses (ripple pulses) increases caused by high-frequency noise.

### DETAILED DESCRIPTION

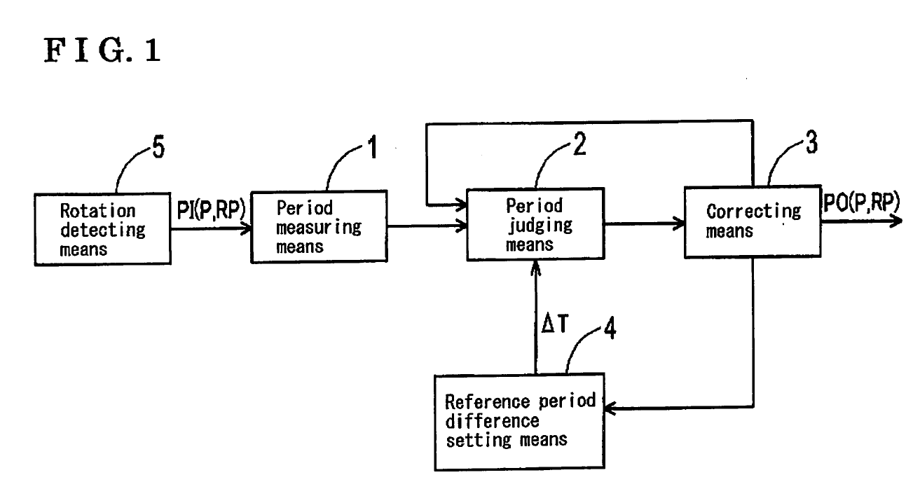

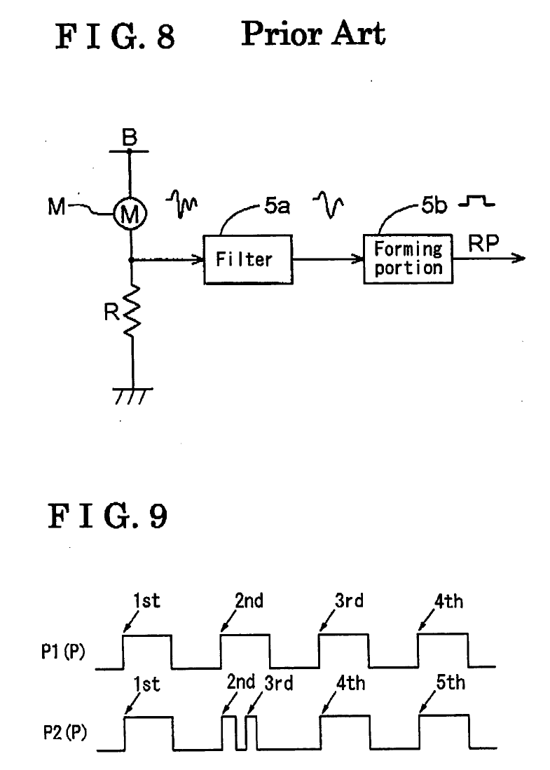

An embodiment of the present invention will be explained with reference to drawing figures. FIG. 1 represents a block diagram typically illustrating a configuration of a rotational state detecting apparatus according to the embodiment of the present invention. A rotation detecting means 5 outputs a detection pulse P corresponding to rotation of a direct current motor. Various kinds of means can serve as specific examples of the rotation detecting means 5. For example, an encoder, in which a slit plate and a photo interrupter are utilized, and a rotation sensor, in which a magnetic sensor is utilized, as described above, or the like, can serve as examples. As a configuration example illustrated in FIG. 8, as the detection pulse P, a ripple pulse RP can be obtained by forming a ripple of current flowing in the direct current motor. In other words, various kinds of means can serve as the rotation detecting means 5 if a pulse signal can be obtained.

As described above, there can be a situation where the detection pulse P receives influence from high-frequency noise and is divided as illustrated in FIG. 9. In other words, there can be a situation where detection pulses P include rotation pulses indicating a rotational frequency of the direct current motor and divided pulses, which are divisions of the rotation pulse. In particular, in a situation where the ripple pulse RP is obtained from ripple current of the direct current motor, there can be a situation where the rotation pulse is divided by high-frequency noise caused by harmonic components of a ripple frequency. Here, for recovering the rotation pulse from the divided pulses, the rotational state detecting apparatus according to the embodiment of the present invention includes a period measuring means 1, a period judging means 2, a correcting means 3 and a reference period difference setting means 4. In the following explanation, the detection pulse P before recovery will be referred to as an input pulse PI, and the detection pulse P after the recovery will be referred to as an output pulse PO in appropriate situations.

The period measuring means 1 measures a period of the input pulse (detection pulse) PI. The period judging means 2 judges whether the input pulse PI is the rotation pulse or the divided pulse, which is a division of the rotation pulse. Specifically, the period judging means 2 judges that the input pulse (detection pulse) PI is the divided pulse in a situation where the value of a period difference between a most recent rotation pulse and the measured input pulse (detection pulse) PI is larger than that of a reference period difference ΔT. In a situation where the input pulse (detection pulse) PI is judged to be the divided pulse, the correcting means 3 corrects the period of the detection pulse P to a combined period of plural serial divided pulses and generates the rotation pulse PO having the combined period.

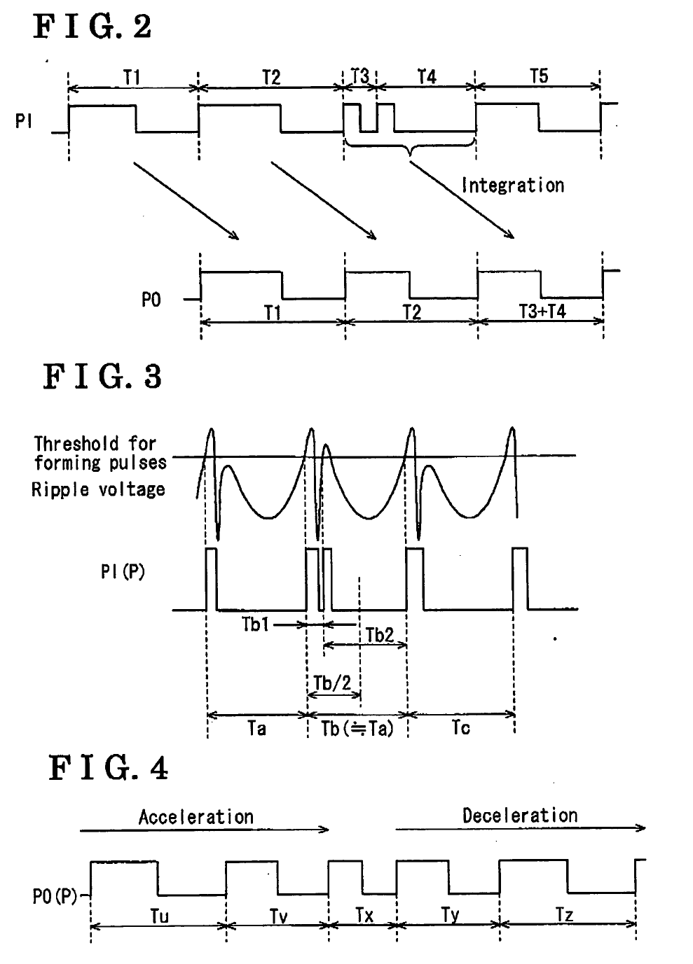

As illustrated in a waveform chart of FIG. 2, the period measuring means 1 sequentially measures periods T1, T2, T3, T4, T5 . . . of input pulses PI. The period judging means 2 judges, for example, whether the value of a period difference between a period T1 of the most recent rotation pulse (output pulse PO) and a period T2 of the measured input pulse PI is larger than that of the reference period difference ΔT or not Because T1≅T2, as described below, in a situation where ΔT is approximately a half of the period of the rotation pulse, the period difference can be sufficiently smaller than the reference period difference ΔT. Accordingly, the input pulse PI, which has the period T2, is not judged as the divided pulse. Relation between the period T2 of the most recent rotation pulse (output pulse PO) and a period T3 of the measured input pulse PI is, as can be clearly seen from the diagram, T2>T3. Because the value of a period difference between T2 and T3 is larger than that of the reference period difference ΔT, the input pulse PI of the period T3 is judged as the divided pulse.

The correcting means 3 integrates the divided pulses (period T3 and period T4) to recover the rotation pulse from the input pulses PI. Specifically, the correcting means 3 recovers the rotation pulse from the input pulses PI as follows in cooperation with the period judging means 2. The period judging means 2 calculates a period of a pulse integrated from the divided pulse period T3) and a following input pulse PI (summation can be performed by the correcting means 3 also). In an example illustrated in FIG. 2, the period T3 is summed with a period T4. Then, the period judging means 2 judges a period difference between the period of the most recent rotation pulse and the summed (combined) period. In the example illustrated in FIG. 2, the summed period (T3+T4) is approximately equal to the period T2 of the most recent rotation pulse (output pulse PO). Accordingly, the value of the period difference becomes sufficiently smaller than that of the reference period difference ΔT, and the summed period is judged as the period of the rotation pulse. The correcting means 3 generates an integrated pulse of the summed period. The generated pulse becomes the output pulse PO, which has been recovered as the rotation pulse.

In the meantime, the value of the reference period difference ΔT is set corresponding to the rotational frequency of the direct current motor. In other words, the value of the reference period difference ΔT is set corresponding to the period of the rotation pulse. In a situation where the period of the rotation pulse is short, the value of the reference period difference ΔT becomes small. In a situation where the period of the rotation pulse is long, the value of the reference period difference ΔT becomes large. In one embodiment, the value of the reference period difference ΔT can be set equal to or lower than approximately a half of the period of the rotation pulse.

In many cases, division of the input pulse PI is caused by high-frequency noise (ringing noise, harmonic noise, or the like) generated at the time of transient response such as rise or fall of pulses (refer to FIG. 3). Because oscillations caused by the transient response converge logarithmically, magnitude (in this situation, amplitude) thereof becomes smaller as time elapses to a last half side of the period. Accordingly, phenomena, in which the rotation pulse is divided into the divided pulse, also converge in the last half of the period. Therefore, it can be assumed that a first divided pulse appears in approximately a first half cycle of the period (refer to FIG. 3).

As illustrated in FIG. 3, in an example, in which a ripple voltage is formed into a pulse, the rotation pulse, which has a period Tb, which is approximately equal to a period Ta, is divided into two divided pulses, which have periods Tb1 and Tb2. The period Tb1 of the first divided pulse is smaller than a half of the period Tb as the rotation pulse. Accordingly, the value of a difference (Ta−Tb1) between the period Ta of the most recent rotation pulse and the period Tb1 of the divided pulse becomes larger than Tb/2. Because the rotation of the direct current motor does not drastically change at the time of steady operation, there is not a large difference between the value of the period Ta of the most recent rotation pulse and that of the period Tb as the rotation pulse. Accordingly, the value of the reference period difference ΔT is determined corresponding to that of the period of the most recent rotation pulse. Because the value of the reference period difference ΔT is sequentially renewed, the value of the reference period difference ΔT can track changes of the rotational frequency of the direct current motor even in a situation where the rotational frequency of the direct current motor changes.

In the meantime, in one embodiment, the value of the reference period difference ΔT was set to a half of that of the period of the most recent rotation pulse. However, a ratio of the reference period difference ΔT to the period of the most recent rotation pulse can be appropriately set corresponding to a direct current motor in use. As a matter of course, the value of the reference period difference ΔT can be changed according to specifications and aging of the direct current motor. Further, the value of the reference period difference ΔT is not necessarily determined in terms of a ratio to the period of the most recent rotation pulse. The value of the reference period difference ΔT can be set by other methods, for example, by subtracting a certain value from the value of the period of the most recent rotation pulse.

As described above, the value of the reference period difference ΔT can be appropriately determined. The value of the reference period difference ΔT is set to a value larger than that of a period difference between the rotation pulses generated at the time of maximum acceleration or deceleration of the direct current motor. In a situation where the direct current motor accelerates or decelerates, some extent of difference is generated between the periods of serial rotation pulses. In a situation where the value of the reference period difference ΔT is set to a small value, there can be a possibility that the value of a period difference between the periods generated by acceleration or deceleration becomes larger than that of the reference period difference ΔT. In this situation, despite an absence of the divided pulse generation, erroneous detection of the divided pulse may occur. Accordingly, the value of the reference period difference ΔT is set to a value larger than that of the period difference between the rotation pulses generated at the time of maximum acceleration or deceleration of the direct current motor.

For example, at the time of acceleration/deceleration illustrated in FIG. 4, in a situation where a period difference (Tu−Tv) is a period difference at the time of maximum acceleration and a period difference (Tz−Ty) is a period difference at the time of maximum deceleration, the value of the reference period difference ΔT can be determined to a value larger than that of both period differences.

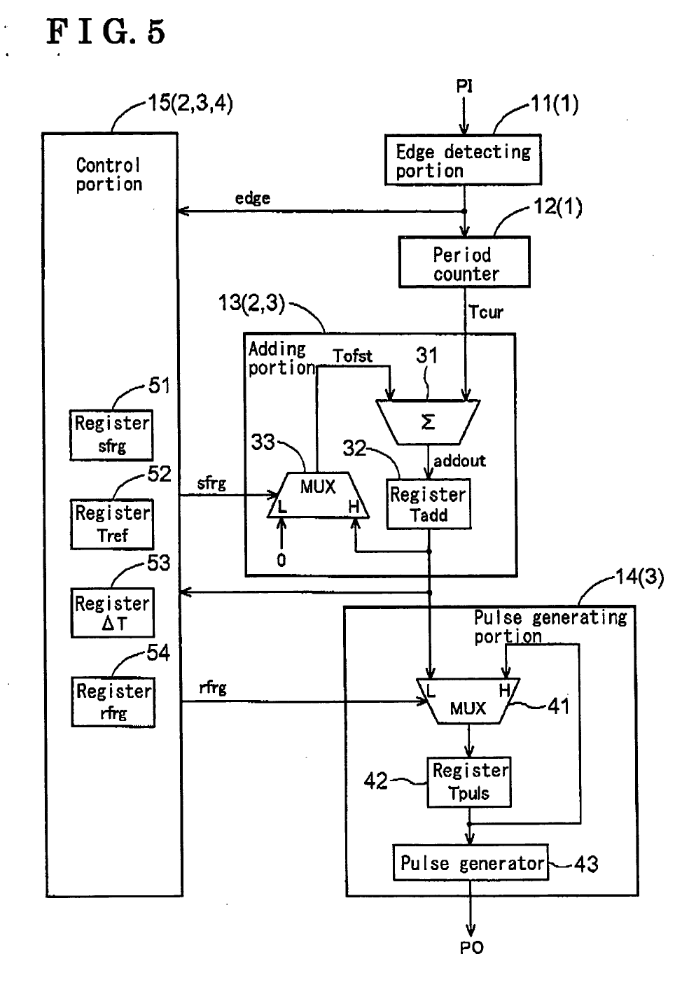

An example of the embodiment of the present invention will be explained with reference to FIGS. 5 to 7. FIG. 5 represents a block diagram typically illustrating a configuration example of the rotational state detecting apparatus according to the example of the embodiment of the present invention, in which the period measuring means 1, the period judging means 2, the correcting means 3, and the reference period difference setting means 4 are realized by hardware. Entire blocks illustrated in FIG. 5 can also be configured with use of an application specific integrated circuit (ASIC), a field programmable gate array (FPGA) and/or a complex programmable logic device (CPLD). Entire blocks illustrated in FIG. 5 can also be configured from combinations with a microcomputer, a processor such as a digital signal processor (DSP), or the like.

As illustrated in FIG. 5, the rotational state detecting apparatus includes an edge detecting portion 11, a period counter 12, an adding portion 13, a pulse generating portion 14 and a control portion 15. The edge detecting portion 11 and the period counter 12 mainly correspond to the period measuring means 1. The adding portion 13 corresponds to the period judging means 2 and the correcting means 3. The pulse generating portion 14 corresponds to the correcting means 3. The control portion 15 corresponds to the period judging means 2, the correcting means 3 and the reference period difference setting means 4 of the embodiment of the present invention Each means described above indicates assigned function. Each means does not necessarily indicate a physically separated apparatus. An example detailed below is one mode to carry out the embodiment of the present invention. Accordingly, other hardware configurations, cooperation with software run on hardware, or the like, can be employed if each function is assigned thereto.

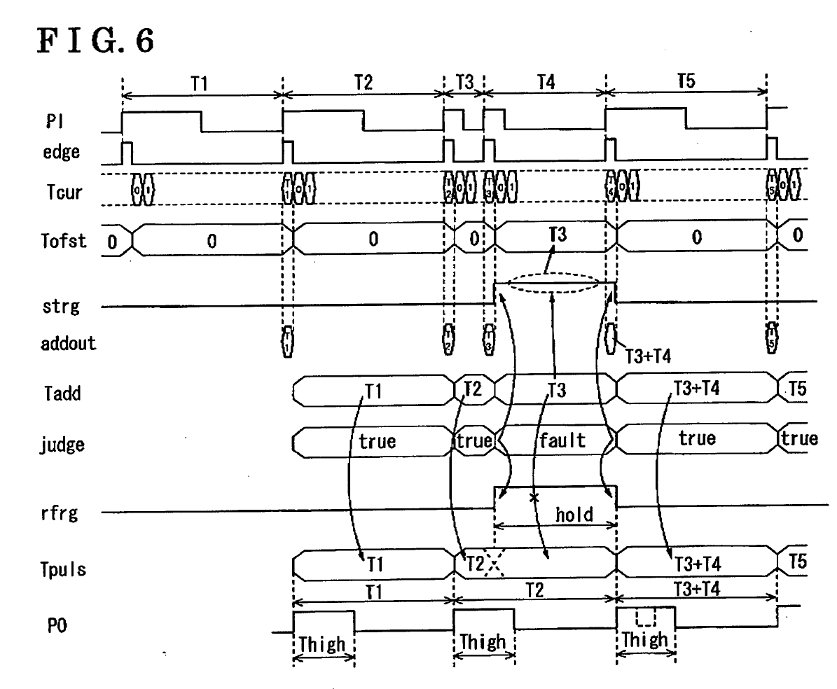

As illustrated in FIG. 6, the edge detecting portion 11 detects an edge of the input pulse PI (detection pulse P, ripple pulse RP). In the present example, the edge detecting portion 11 differentiates a rising edge of the input pulse PI and outputs an edge detection signal edge. The edge detection signal edge is inputted to various kinds of blocks as a basis of control. In FIG. 5, for simplicity of illustration, only inputs to the control portion 15 and to the period counter 12 are illustrated.

The period counter 12 resets a count value Tcur on the basis of the edge detection signal edge. After that, the period counter 12 increments the count value Tcur until next edge detection signal edge is inputted. As illustrated in FIG. 6, the count values Tcur become T1, T2, T3, . . . corresponding to the periods T1, T2, T3, . . . of the input pulses PI respectively. Thus, the periods of the input pulses PI are counted.

The adding portion 13 sums the count value Tcur with an offset value Tofst by an adder 31. An initial value of the offset value Tofst is zero. On the basis of a control signal sfrg from the control portion 15, and with use of a multiplexer 33, Tadd stored in a register 32 or zero is selected (refer to FIG. 5). In a situation where the offset value Tofst is zero, the adder 31 outputs the. count value Tcur as a summation result addout. In the register 32, the summation result addout is stored as Tadd according to timing of the edge detection signal edge. In other words, a value of the register 32 is renewed every time an edge is detected (refer to FIG. 6). The value Tadd of the register 32 is outputted to the control portion 15 and the pulse generating portion 14.

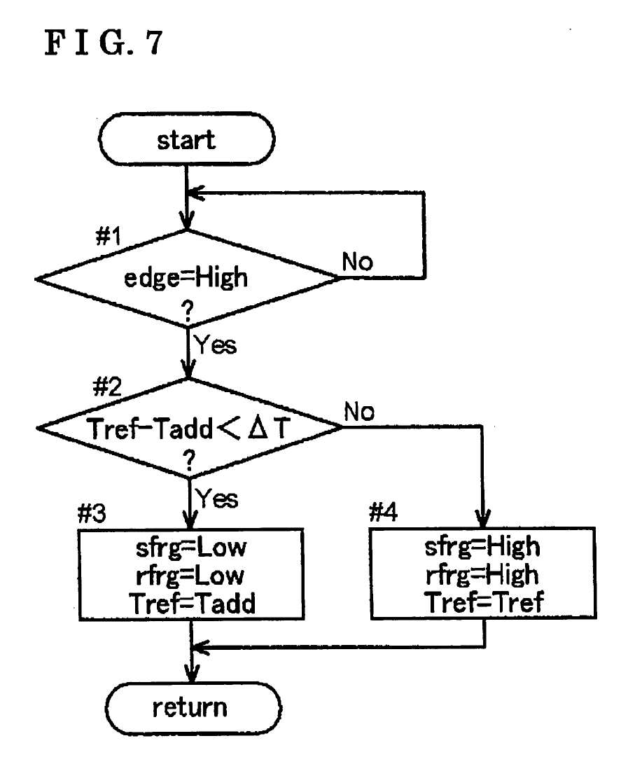

The control portion 15 performs controls illustrated in a flowchart of FIG. 7 in a situation where the edge detection signal edge from the edge detecting portion 11 and the register value Tadd from the adding portion 13 are inputted. In the controls, ΔT (reference period difference) and Tref (period of the most recent rotation pulse) stored in registers 53 and 52 of the control portion 15 are utilized.

In a situation where the control portion 15 confirms that the edge detection signal edge is active (=High) (#1), the control portion 15 judges whether the value of a difference between Tref and Tadd is smaller than that of the reference period difference ΔT or not (#2). Because Tadd is a period of the input pulse PI, the difference between Tref and Tadd corresponds to a period difference between “the period of the most recent rotation pulse” and “the period of the measured input pulse PI (detection pulse)”. In a situation where the value of the period difference is smaller than that of the reference period difference ΔT, the measured input pulse PI is judged as the rotation pulse. In the meantime, in a timing chart of FIG. 6, the judgment is indicated by that “judge” becomes “true”.

In a situation where the input, pulse PI is judged not to be the divided pulse but to be the rotation pulse, values in registers 51, 52, and 54 are set as follows (#3). In the register 51, the control signal sfrg is set to Low. In a situation where next input pulse PI is evaluated, zero is selected as the value of Tofst in the adding portion 13. In the register 52, the period Tadd of the input pulse PI, which has been judged as the rotation pulse, is stored as the period Tref of the most recent rotation pulse. In other words, the value of the Tref is renewed for next judgment. In the register 54, a control signal rfrg is set to Low. The control signal rfrg is utilized in the pulse generating portion 14.

In the meantime, though it is not illustrated in FIG. 7, the value of the reference period difference ΔT is also recalculated on the basis of the value of Tadd, and the recalculated result is stored in the register 53. For evaluation of the period of the next input pulse PI, the value of the reference period difference ΔT after renewal is utilized. As described above, the control portion 15 also functions as a reference period difference setting means 4 illustrated in FIG. 1.

The pulse generating portion 14 generates and outputs the output pulse PO (detection pulse) on the basis of a period (Tpuls) of the rotation pulse. A register 42, in which Tpuls is stored, is renewed every time an edge of the input pulse PI is detected. In a situation where the control signal rfrg is Low, on the basis of the control signal rfrg and with use of a multiplexer 41, Tadd is selected and is stored in the register 42 as Tpuls. Tpuls is a value, which determines a period of the output pulse PO. A pulse generator 43 reads the value of Tpuls from the register 42, and memorizes the value of Tpuls as required basis. Then, the pulse generator 43 generates and outputs the output pulse PO, of which duration of High is a fixed value Thigh, and of which a period is Tpuls (refer to FIG. 6). For the output pulse PO outputted to a rotation detecting portion as the detection pulse P (ripple pulse RP), the number of pulses is important, but a duty ratio is not important. Accordingly, in the example, the duration of High of the output pulse PO is set to a fixed value Thigh, which enables to simplify a configuration of the pulse generator 43. For setting a duty ratio to be constant, Thigh can be a function of Tpuls. For example, in a situation where Thigh=Tpuls/2, a duty ratio becomes 1:1.

Next, a situation where the input pulse PI is the divided pulse will be explained taking a situation where the periods of the input pulses PI is T3 and T4 in the timing chart of FIG. 6. Operations of the edge detecting portion 11 and the period counter 12 are as described above. Because the period T2 is the period as the rotation pulse, Tofst is zero. Accordingly, the adding portion 13 outputs a summation results calculated under a condition that Tadd=T3 to the control portion 15 and the pulse generating portion 14. The control portion 15 calculates as follows and judges the period of the input pulse P1.
Tref−Tadd=T2−T3>ΔT(≅T2/2)

From the calculation result described above, the input pulse PI is judged as the divided pulse. As illustrated in the timing chart of FIG. 6, “judge” becomes “fault”. Then, as illustrated in the flowchart of FIG. 7, values of the registers 51, 52, and 54 are set as follows (#4).

In the register 51, the control signal sfrg is set to High. By this, at the time of evaluation of the next input pulse PI, Tadd (=T3) is selected as a value of Tofst in the adding portion 13. In the register 52, a value of Tref (=T2) is retained. It is because it is not judged that there is a new rotation pulse, and the value of the period Tref (=T2) of the most recent rotation pulse is not changed. In the meantime, similarly to Tree the value of the reference period difference ΔT is not recalculated either. Or, even in a situation where the value of the reference period difference ΔT is recalculated, because Tref is the same value, the value of the reference period difference ΔT is renewed to the same value. In the register 54, the control signal rfrg is set to High.

In a situation where the control signal rfrg is High, the value of previously renewed Tpuls (=the period T2 of the rotation pulse) is selected on the basis of the control signal rfrg and with use of the multiplexer 41 and is retained in the register 42. The pulse generating portion 14 continuous a process to generate and output the output pulse PO on the basis of the period Tpuls set at the time of detection of the previous edge. Accordingly, the output pulse PO of an original period T2 is generated and outputted without being influenced from the divided pulse.

Next, as illustrated in the timing chart of FIG. 6, after the period T3 of the input pulse PI, a period T4 is measured. The counted value Tcur (=T4) of the period counter 12 is inputted to the adder 31 of the adding portion 13. In the adding portion 13, because the control signal sfrg for controlling the multiplexer 33 is High, Tadd (=T3) stored in the register 32 is inputted to the adder 31 as the offset value Tofst. The adder 31 performs summation as follows.
Tofst+Tcur=T3+T4

The register 32 stores the summation result addout as Tadd on the basis of the edge detection signal edge. The value Tadd (=T3+T4) of the register 32 is outputted to the control portion 15 and the pulse generating portion 14. The control portion 15 calculates as follows and judges whether the summation Tadd of two periods can be a period of the recovered output pulse PO (detection pulse P) or not. In other words, the control portion 15 assumes that the input pulse PI has a period T3+T4, and judges whether the input pulse PI can be approved as the rotation pulse or not.
Tref−Tadd=T2−(T3+T4)<ΔT(≅T2/2)

From the calculation result described above, a virtual input pulse PI (summed period T3+T4) is judged as the rotation pulse. In the timing chart of FIG. 6, “judge” becomes “true”. Then, in the flowchart of FIG. 7, values of the registers 51, 52, and 54 are set as follows (#3). In the meantime, here, in a situation where “Tref−Tadd (summed period)” is larger than, ΔT as before, the same processes are repeated. In other words, even in a situation where the rotation pulse is divided into three or more, the summed period can be obtained by the processes in the example, and after it is judged that the summed period is smaller than ΔT, the period of the rotation pulse can be recovered.

In a situation where the virtual input pulse PI (period T3+T4) is judged not to be the divided pulse but to be the rotation pulse, the values of the registers 51, 52, and 54 are set as follows (#3). In the register 51, the control signal sfrg is set to Low. By this, at the time of evaluation of the next input pulse PI, zero is selected as the value of Tofst in the adding portion 13. In the register 52, Tadd (=T3+T4, summed period), which has been approved as the period of the rotation pulse, is stored as the period Tref of the most recent rotation pulse. In other words, the value of Tref is renewed for next judgment. In the register 54, the control signal rfrg is set to Low.

In the meantime, the value of the reference period difference ΔT is also recalculated on the basis of the value of Tadd, which is the summed period. The recalculated result is stored in the register 53. For evaluation of the period of the next input pulse PI, the value of the reference period difference ΔT after renewal is utilized.

In the register 42 of the pulse generating portion 14, Tadd (=T3+T4) is stored as Tpuls on the basis of the edge detection signal edge. The pulse generator 43 generates and outputs the output pulse PO, of which the duration of High is the fixed value Thigh, and of which the period is Tpuls (=T3+T4) (refer to FIG. 6). As described above, the detected divided pulses are integrated, the rotation pulse is recovered from the input pulse PI (detection pulse P, ripple pulse RP), and the output pulse PO (detection pulse P, ripple pulse RP) is outputted.

As explained above, in the example, the adding portion 13 sums the periods of the serially measured plural divided pulses in cooperation with the control portion 15. The control portion 15 judges the summation of the periods of plural divided pulses as the period of the detection pulse P. The pulse generating portion 14 recovers the detection pulse P on the basis of the summed period. As described above, the edge detecting portion 11 and the period counter 12 mainly correspond to the period measuring means 1. The adding portion 13 corresponds to the period judging means 2 and the correcting means 3. The pulse generating portion 14 corresponds to the correcting means 3. The control portion 15 corresponds to the period judging means 2, the correcting means 3 and the reference period difference setting means 4 according to the embodiment of the present invention. Accordingly, according to the example described above, the rotational state detecting apparatus according to the embodiment of the present invention, including the period measuring means 1, the period judging means 2, and the correcting means 3, can be realized.

As explained above, according to the embodiment of the present invention, a rotational state detecting apparatus, in which influence from high-frequency noise can be restricted, and which can accurately detect a rotational state, in particular, a rotational frequency, of a direct current motor, can be provided.

According to an aspect of the present invention, a rotational state detecting apparatus for detecting a rotational state of a direct current motor using a detection pulse outputted corresponding to rotation of the direct current motor includes a period measuring means for measuring a period of the detection pulse, a period judging means for judging whether the detection pulse is a rotation pulse indicating a rotational frequency of the direct current motor or a divided pulse into which the rotation pulse is divided on the basis of a period difference between a most recent rotation pulse and the detection pulse and a correcting means for correcting the period of the detection pulse to a combined period of a plurality of serial divided pulses and generating the rotation pulse having the combined period in a situation where the detection pulse is judged to be the divided pulse.

In a situation where the detection pulse outputted corresponding to the rotation of the direct current motor receives high-frequency noise, or, in a situation where the detection pulse formed under influence of high-frequency noise is outputted, the rotation pulse, which indicates the rotation of the direct current motor, is divided. In other words, the rotation pulse is divided into a plurality of divided pulses, which has a period shorter than an actual period. Generally, periods of the serial rotation pulses do not have large difference therebetween in a situation where the rotation of the direct current motor is correctly indicated. Accordingly, as in the configuration described above, the detection pulse can be judged to be the rotation pulse or the divided pulse from the period difference between the most recent rotation pulse and the detection pulse. Because divided pulses are divisions of the rotation pulse, integration of the judged divided pulses enables to recover an original rotation pulse. According to the aspect of the present invention, there is no need of using powerful noise filters. Further, attenuation of signals caused by noise filters does not occur. Accordingly, the detection pulse, which accurately indicates the rotation of the direct current motor, can be obtained. Accordingly, a rotational state detecting apparatus, in which influence from high-frequency noise can be restricted, and which can accurately detect a rotational state, in particular, a rotational frequency, of a direct current motor, can be provided.

Here, furthermore, the detection pulse can be a ripple pulse obtained from a ripple current outputted from the direct current motor corresponding to the rotation of the direct current motor.

A method to detect the rotational frequency with use of ripple current flowing in the direct current motor is simple and effective. On the other hand, in a situation where a brush in contact with an armature wears, high-frequency noise of the ripple current tends to be large. In many cases, the high-frequency noise is harmonic components of a ripple frequency. Accordingly, the rotation pulse is divided at approximately a constant position (a position within the period) of the rotation pulse. In other words, the rotation pulse is divided into plural pulses without influence to the period of the rotation pulse. Accordingly, integration of the divided pulses can accurately recover the original rotation pulse. Generally, noise of ripple pulses increases corresponding to aging (wear of contacting portions such as a brush) of the direct current motor. However, the method, in which the divided pulses are integrated, can retain effect of correction without influence from aging. As described above, according to the aspect of the present invention, a rotational state detecting apparatus, in which a detection pulse can be obtained by a simple method, and in which influence from high-frequency noise can be restricted, and which can accurately detect a rotational frequency of the direct current motor, can be provided.

Furthermore, the period judging means can judge that the detection pulse is the divided pulse in a situation where the value of the period difference is larger than that of a reference period difference, and the value of the reference period difference can be set corresponding to a rotational frequency of the direct current motor.

The judgment whether the detection pulse is the divided pulse or not is made on the basis of the value of the period difference between the period of the divided pulse and the period of the most recent rotation pulse. Accordingly, in a situation where the reference period difference, which is a base of judgment, is a fixed value, there can be a situation where a relation between the value of the period of the rotation pulse, which differs corresponding to rotational speed, and that of the reference period difference largely fluctuates, which tends to cause lack of stability in judgment results. Here, in the aspect of the present invention, the value of the reference period difference is set corresponding to the rotational frequency (rotational speed) of the direct current motor. By doing so, fluctuation in the relation between the value of the period of the rotation pulse and that of the reference period difference can be small, and stability in the judgment results can be improved. Then, because the value of the reference period difference is sequentially renewed, the value of the reference period difference can preferably track changes of the rotational frequency of the direct current motor even in a situation where the rotational frequency of the direct current motor changes.

For example, the value of the reference period difference can be determined on the basis of that of the period of the most recent rotation pulse. The rotation of the direct current motor does not drastically change at the time of steady operation. Accordingly, there's not so large difference between the period of the most recent rotation pulse and the period of the detection pulse as the rotation pulse. Further, because the period of the rotation pulse indicates rotational speed of the direct current motor, the value of the reference period difference can be preferably determined by doing so. Further, for another example, the value of the reference period difference can be set to a half of that of the period of the most recent rotation pulse. In many cases, division of the detection pulse is caused by high-frequency noise (ringing noise, harmonic noise, or the like) generated at the time of transient response such as rise or fall of pulses. Because oscillations caused by the transient response converges logarithmically, magnitude (in this situation, amplitude) thereof becomes small in approximately a half cycle of the period to the extent that the oscillation does not influence in forming pulses. Accordingly, phenomena, in which the rotation pulse is divided into the divided pulses, occurs in a range of approximately half cycle of the period. Therefore, it can be assumed that the period of the divided pulse does not exceed approximately a half cycle of the period. In a situation where the value of the reference period difference is set to a half of that of the period of the most recent rotation pulse, calculation load can be light, stability in the judgment results can be good, and the reference period difference can preferably track the changes of the rotational frequency of the direct current motor.

Furthermore, the period judging means can judge that the detection pulse is the divided pulse in a situation where the value of the period difference is larger than that of a reference period difference, and the value of the reference period difference can be set to a value larger than that of a period difference between rotation pulses generated at the time of maximum acceleration/deceleration of the direct current motor.

In a situation where the direct current motor accelerates or decelerates, some extent of difference is generated between the periods of the serial rotation pulses. In a situation where the reference period difference is set to a small value, there can be a possibility that the value of difference between the periods generated by acceleration or deceleration becomes larger than that of the reference period difference. In this situation, despite an absence of the divided pulse generation, erroneous detection of the divided pulse occurs. As the aspect of the present invention, in a situation where the value of the reference period difference is set to a value larger than that of the difference between the periods of the rotation pulses generated at the time of maximum acceleration or deceleration of the direct current motor, such problems does not arise, and stable judgment results can be obtained.

The principles, preferred embodiment and mode of operation of the present invention, have been described in the foregoing specification. However, the invention that is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. A rotational state detecting apparatus for detecting a rotational state of a direct current motor using a detection pulse outputted corresponding to rotation of the direct current motor, comprising:
a period measuring means for measuring a period of the detection pulse;
a period judging means for judging whether the detection pulse is a rotation pulse indicating a rotational frequency of the direct current motor or a divided pulse into which the rotation pulse is divided on the basis of a period difference between a most recent rotation pulse and the detection pulse; and
a correcting means for correcting the period of the detection pulse to a combined period of a plurality of serial divided pulses and generating the rotation pulse having the combined period in a situation where the detection pulse is judged to be the divided pulse.

2. The rotational state detecting apparatus according to claim 1, wherein
the detection pulse is a ripple pulse obtained from a ripple current outputted from the direct current motor corresponding to the rotation of the direct current motor.

3. The rotational state detecting apparatus according to claim 1, wherein
the period judging means judges that the detection pulse is the divided pulse in a situation where the value of the period difference is larger than that of a reference period difference, and the value of the reference period difference is set corresponding to a rotational frequency of the direct current motor.

4. The rotational state detecting apparatus according to claim 1, wherein
the period judging means judges that the detection pulse is the divided pulse in a situation where the value of the period difference is larger than that of a reference period difference, and the value of the reference period difference is set to a value larger than that of a period difference between rotation pulses generated at the time of maximum acceleration/deceleration of the direct current motor.

5. The rotational state detecting apparatus according to claim 2, wherein
the period judging means judges that the detection pulse is the divided pulse in a situation where the value of the period difference is larger than that of a reference period difference, and the value of the reference period difference is set corresponding to a rotational frequency of the direct current motor.

6. The rotational state detecting apparatus according to claim 2, wherein
the period judging means judges that the detection pulse is the divided pulse in a situation where the value of the period difference is larger than that of a reference period difference, and the value of the reference period difference is set to a value larger than that of a period difference between rotation pulses generated at the time of maximum acceleration/deceleration of the direct current motor.
